(19) United States
(12) Patent Application Publication
(10) Pub. No.: US 2008/0077893 A1
(43) Pub. Date: Mar. 27, 2008

(54) Method for verifying interconnected blocks of IP

(75) Inventors: Steven Korson, Murphy, TX (US); Hao Luan, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/527,342

(22) Filed: Sep. 26, 2006

(51) Int. Cl. G06F 17/50; G06F 9/45

(52) U.S. Cl. 716/5

(57) ABSTRACT

The present invention provides a method for verifying interconnected blocks in a top-block by creating one or more assertions for each input/output of one or more blocks to be used within the top-block, creating one or more assertions for each input/output of the top-block, providing a stimulus intended to cause each assertion to be triggered, and verifying that a result for each assertion was correct. The assertions verify that a valid functional mode caused a change in an output or a valid functional mode received the change in an input. A computer program embodied on a computer readable medium can implement the foregoing steps as one or more code segments.

### FIELD OF THE INVENTION

The present invention relates generally to the field of integrated circuit design and, more particularly, to a method for verifying interconnected blocks.

### BACKGROUND OF THE INVENTION

One method of designing electronic systems, such as integrated circuits, is block based design wherein the system is designed by integrating existing component design blocks (sub-blocks) into a larger block (top-block). A top-block can be used as a sub-block in yet another design. These pre-designed blocks may originate as internally created or obtained from design firms. These blocks, intellectual property blocks (“IP blocks”), can be in Application-Specific Integrated Circuit (“ASIC”) or Field Programmable Gate Array (“FPGA”) designs. A long standing and difficult problem with this design process is how to know that the interconnections of the sub-blocks are being completely verified with optimal tests. Current methods, such as functional coverage identified at integration time and toggle coverage, can not reliably indicate that a functional aspect of each interconnect has been validated. Current methods suffer from requiring the IP integration engineers to know as much about the IP block being integrated as the original designer. As a result, there is a need for a method for verifying interconnected blocks of ASIC or FPGA IP blocks using targeted assertions developed by the block designer to drive the testing of the top-block.

### SUMMARY OF THE INVENTION

The present invention provides a method for verifying interconnected blocks (smaller designs or sub-blocks) of ASIC or FPGA IP using a targeted, finite set of assertions as a metric for completion. Design technologies, either in form of tools or papers, exist to identify sub-block inputs/outputs (I/Os) that have or are missing assertions. These technologies can also identify from a set of assertions for a block which assertions are related to the I/Os. With these technologies, a set of assertions that affect the inputs and outputs of a block can be identified. The assertions on the inputs note that the input toggled during a mode when the input was being used by the receiving IP module. In this manner, the activity on the input will be checked against assertions to make sure the activity is correct for a particular function mode. Inputs that toggle when the module is not in a mode to receive them will not trigger the assertion. The assertions on the outputs note that when they are toggled the IP sourcing them is in a mode where it is expecting this output to be used. The validation is completed in the top design in a functional manner and the results are measured through the I/O assertions created by the block designer, not through some unrelated metric. Metrics such as simple toggle coverage or random generated tests are design function independent. They provide that a signal needs to be toggled but are independent from the intent of the original IP block designer. Metrics such as functional coverage identified at integration time require the IP integration engineer know more about an IP block than is realistically available. Often access to this information simply is not available.

More specifically, the present invention provides a mechanism to verify that a functional aspect of each interconnect (individual I/O) can be verified, without detailed knowledge of the functionality of the IP block. With this method, functionality that is desired will be identified by passing assertions related to those I/O pins related to the particular function. Functionality that is not connected properly will cause failing assertions. These will indicate the nature of the impact, which can then be identified and rectified. Unused functionality that is properly disabled will be identified by passing assertions. Unused functionality improperly connected will be identified by failing assertions. This validation of unused functions is a key aspect of this method that is impossible to be detected by toggle coverage metrics, and very difficult at best with directed coverage or test cases. The non-triggered assertions are used to direct the top tests to cover untested functionality, whether desired or unused. For example, after a test is run, if all the assertions are not triggered, the test bench is changed and the test is rerun. If, however, all the assertions are not triggered, and all the assertions did not pass, the design, assertions or test bench is changed and the test is rerun. The test is complete when all the assertions are triggered and pass. The present invention achieves the same or better results as traditional dynamic simulation methods, but requires less time and effort.

For example, the present invention provides a method for verifying interconnected blocks in a top-block by creating one or more assertions for each input/output of one or more IP blocks to be used within the top-block, creating one or more assertions for each input/output of the top-block, providing a stimulus intended to cause each assertion to be triggered, and verifying that a result for each assertion was correct. A computer program embodied on a computer readable medium can implement the foregoing steps as one or more code segments.

In addition, the present invention provides a method for verifying interconnected blocks in a top-block by creating the top-block with one or more functional modes of operation, defining one or more sub-blocks for the top-block, creating one or more assertions for each input/output of the sub-blocks, creating one or more assertions for each input/output of the top-block, providing a stimulus intended to cause each assertion to be triggered, monitoring and verifying that a result for each assertion was correct, and analyzing the assertions whenever the result is incorrect. The one or more assertions check that the input/output has changed when in a valid functional mode to drive or receive a changing signal.

The present invention is described in detail below with reference to the accompanying drawings.

### BRIEF DESCRIPTION OF THE DRAWINGS

The above and further advantages of the invention may be better understood by referring to the following description in conjunction with the accompanying drawings, in which:

FIG. 1 is a block diagram of an example demonstrating the relationships between sub-blocks, top-blocks, and input/output assertions in accordance with one embodiment of the present invention;

FIG. 2 is a block diagram of a block tester in accordance with one embodiment of the present invention;

FIG. 3 is a flow chart of a method for verifying interconnected blocks in a top-block in accordance with one embodiment of the present invention;

FIG. 4 is a flow chart of a method for verifying that all assertions are triggered and passed in accordance with one embodiment of the present invention; and

FIG. 5 is a flow chart of a method for verifying interconnected blocks in a top-block in accordance with another embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention. The discussion herein relates primarily to the testing of Application-Specific Integrated Circuit (“ASIC”) or Field Programmable Gate Array (“FPGA”) intellectual property blocks (“IP blocks”), but it will be understood that the concepts of the present invention are applicable to any modular design testing system having input and output data (e.g., connections, interconnections, ports, pins, variables, etc.).

The present invention provides a method for verifying interconnected blocks (smaller designs or sub-blocks) of ASIC or FPGA IP using a targeted, finite set of assertions as a metric for completion. Design technologies, either in form of tools or papers, exist to identify sub-block inputs/outputs (I/Os) that have or are missing assertions. These technologies can also identify from a set of assertions for a block which assertions are related to the I/Os. With these technologies, a set of assertions that affect the inputs and outputs of a block can be identified. The assertions on the inputs note that the input toggled during a mode when the input was being used by the receiving IP module. In this manner, the activity on the input will be checked against assertions to make sure the activity is correct for a particular function mode. Inputs that toggle when the module is not in a mode to receive them will not trigger the assertion. The assertions on the outputs note that when they are toggled the IP sourcing them is in a mode where it is expecting this output to be used. The validation is completed in the top design in a functional manner and the results are measured through the I/O assertions created by the block designer, not through some unrelated metric. Metrics such as simple toggle coverage or random generated tests are design function independent. They provide that a signal needs to be toggled but are independent from the intent of the original IP block designer. Metrics such as functional coverage identified at integration time require the IP integration engineer know more about an IP block than is realistically available. Often access to this information simply is not available.

More specifically, the present invention provides a mechanism to verify that a functional aspect of each interconnect (individual I/O) can be verified, without detailed knowledge of the functionality of the IP block. With this method, functionality that is desired will be identified by passing assertions related to those I/O pins related to the particular function. Functionality that is not connected properly will cause failing assertions. These will indicate the nature of the impact, which can then be identified and rectified. Unused functionality that is properly disabled will be identified by passing assertions. Unused functionality improperly connected will be identified by failing assertions. This validation of unused functions is a key aspect of this method that is impossible to be detected by toggle coverage metrics, and very difficult at best with directed coverage or test cases. The non-triggered assertions are used to direct the top tests to cover untested functionality, whether desired or unused. For example, after a test is run, if all the assertions are not triggered, the test bench is, changed and the test is rerun. If, however, all the assertions are not triggered, and all the assertions did not pass, the design, assertions or test bench is changed and the test is rerun. The test is complete when all the assertions are triggered and pass. The present invention achieves the same or better results as traditional dynamic simulation methods, but requires less time and effort.

Assertions are “built in” pieces of design code that check if a piece of code works or not. An example might be an assertion that triggers when a signal that changes from “0” to “1” happens when another signal or mode is true, and does not trigger otherwise. Another example might be an assertion that checks that a signal that is “0” goes to “1” before it goes to “2”. These can also be applied to data, ports, pins or variables of a block in -a similar manner. The assertions simulate the functional nature, modes or constraints of a design (e.g., physical connections exit, connections are used/unused, design functions correctly, etc.). Assertions are “triggered” when the conditions are met no matter if the result is pass or fail.

As used herein, “block” is a piece of a design. The size of the block is not relevant, but its hierarchy is relevant. A “top-block” is the particular assembly of blocks and possibly some design. Note that a top-block in one instance could become a block in another. A “toggle” is the changing of a Boolean logic signal from “0” to “1”, “1” to “0”, x to 0/1 and vice versa, and z to 0/1 and vice versa. Each change is a toggle, and toggle coverage metrics note which of these changes happens for all the requested (usually I/O) signals.

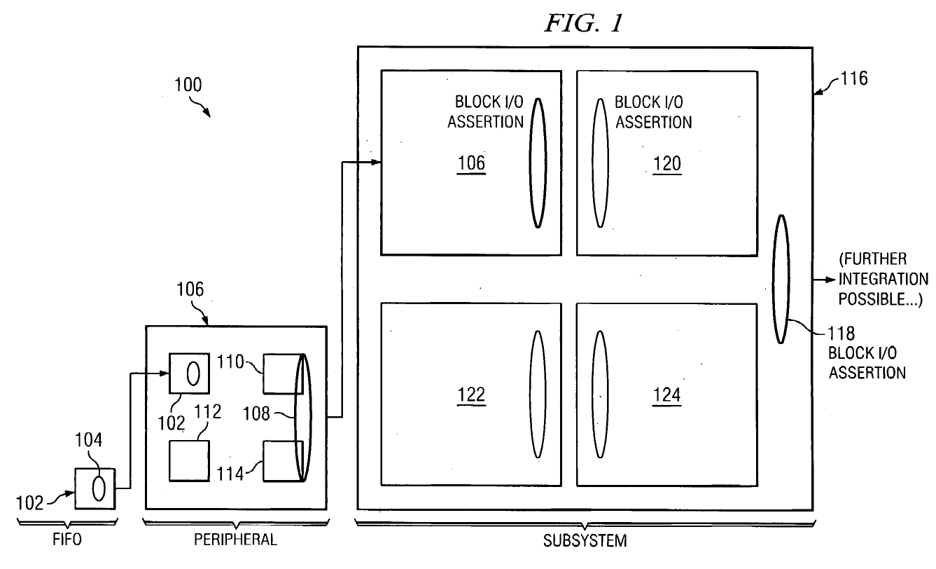

Referring now to FIG. 1, a block diagram of an example 100 demonstrating the relationships between sub-blocks, top-blocks, and I/O assertions in accordance with one embodiment of the present invention is shown. Sub-block 102 has one or more I/O assertions 104. After sub-block 102 has been tested and the assertions 104 have been verified (determined to be correct), sub-block 102 can be incorporated into a larger design, such as peripheral 106, that has one or more I/O assertions 108 and includes other sub-block 110, 112 and 114. The functional modes of sub-block 102 carry forward into peripheral 106. After peripheral 106 has been tested and the assertions. 108 have been verified (determined to be correct), peripheral 106 can be incorporated into a larger design, such as subsystem 116, that has one or more I/O assertions 118 and includes other sub-block 120, 122 and 124. The functional modes of peripheral 106 carry forward into subsystem 116. After subsystem 116 has been tested and the assertions 118 have been verified (determined to be correct), subsystem 116 can be further integrated into larger designs or top-blocks.

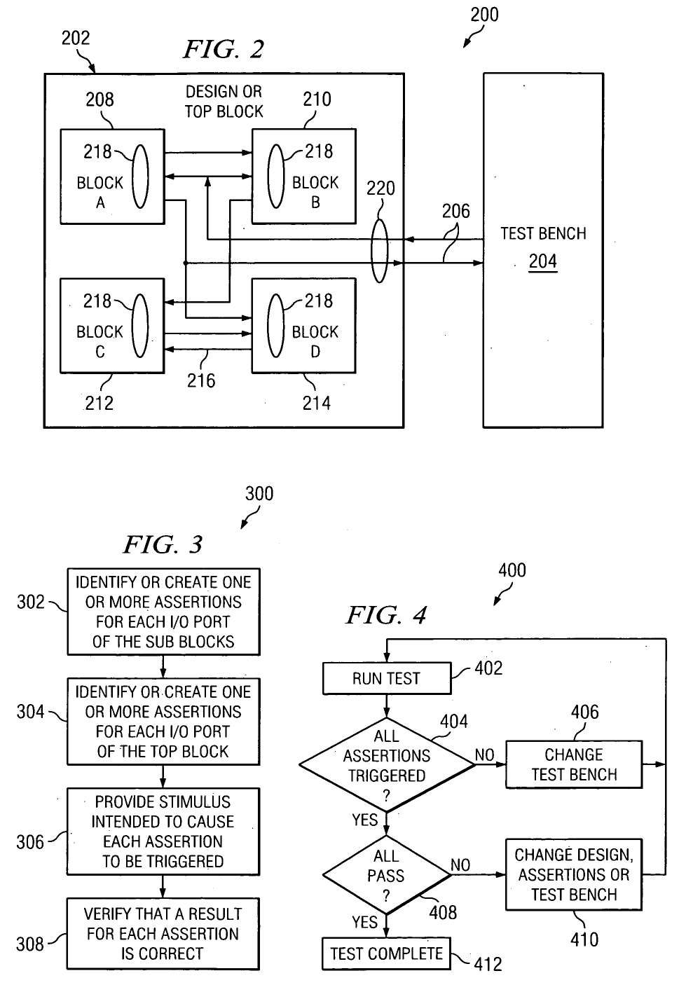

Now referring to FIG. 2, a block diagram of a block tester 200 in accordance with one embodiment of the present invention is shown. The block tester 200, among other elements known to those skilled in the art, includes a design or top-block 202 connected to a test bench 204 by I/Os 206. The top-block 202 includes one or more blocks (e.g., Block A 208, Block B 210, Block C 212, Block D 214, etc.) connected together with interconnects 216. Top-block 202 also includes one or more I/O ports that are connected (or not connected in the case of some inputs) to interconnects 216 or I/Os 206. The top-block 202 may be a circuit system design or an intermediate level block of an ASIC, FPGA or other circuit design system having I/Os. Prior art methods do not adequately test interconnects 216 and I/Os 206.

Referring now to FIG. 3, a flow chart of a method 300 for verifying interconnected blocks 208-214 in a top-block 202 as shown in FIG. 2 in accordance with one embodiment of the present invention is shown. One or more assertions 218 for each input/output of the sub-block ports connected (or not connected in the case of some outputs) to top-block interconnects 216 between one or more blocks 208-214 within the top-block 202 are identified or created in step 302. Note that the input/output port can also be a connection, interconnection, pin, data or variable. The one or more assertions provide information as to one or more circumstances or functional modes needed to have a function change cause a change in a block output port when a valid functional mode or a change in an input port when the receiving block is in a valid functional mode to receive the input change. One or more assertions 220 for each I/O 206 of the top-block 202 are then created in step 304. The assertions 220 form a list of functional aspects for each I/O of the top-block ports connected (or not connected in the case of some inputs) to top-block interconnect 216 or I/O 206. A stimulus intended to cause each assertion to be triggered is provided in step 306. A correct result for each assertion is verified in step 308. The result may indicate that the assertions are triggered, the assertions are not triggered, the triggered assertions passed or the triggered assertions failed. Moreover, a triggered assertion passed may indicate a functional mode was properly connected, used, unused, disabled or enabled. Likewise, a triggered assertion failed-may indicate a functional mode was improperly connected, used, unused, disabled or enabled. A computer program embodied on a computer readable medium can implement the foregoing steps as one or more code segments.

Now referring to FIG. 4, a flow chart of a method 400 for verifying that all assertions are triggered and passed in accordance with one embodiment of the present invention is shown. The test is run in block 402. If all the assertions are not triggered, as determined in decision block 404, the test bench is changed in block 406 and the test is rerun in block 402. If, however, all the assertions are not triggered, as determined in decision block 404, and all the assertions did not pass, as determined in decision block 408, the design, assertions or test bench is changed in block 410 and the test is rerun in block 402. If all the assertions pass, as determined in decision block 408, the test is complete in block 412.

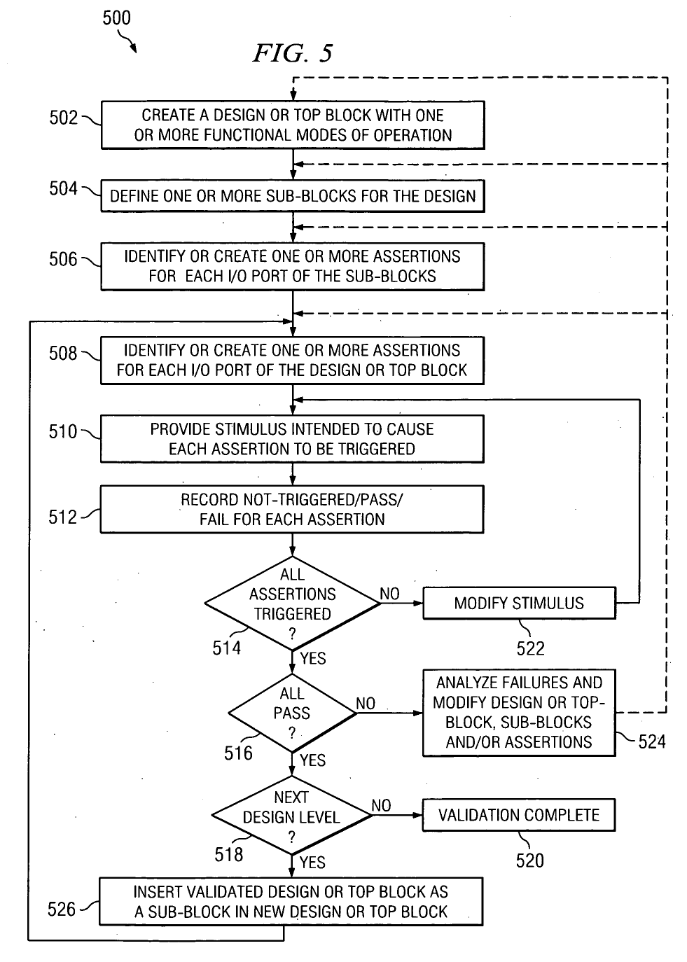

Referring now to FIG. 5, a flow chart of a method 500 for verifying interconnected blocks 208-214 in a top-block 202 in accordance with another embodiment of the present invention is shown. The design or top-block 202 is identified or created with one or more functional modes in step 502 and one or more sub-blocks are defined in step 504. One or more assertions 218 for each I/O of the sub-block ports connected (or not connected in the case of some outputs) to top-block interconnect 216 between one or more blocks 208-214 within the top-block 202 are created in step 506. Note that the I/O port can also be a connection, interconnection, pin, data or variable. The one or more assertions provide information as to one or more circumstances needed to have a function change cause a change in a port of a block. One or more assertions 220 for each I/O 206 of the top-block 202 are then created in step 508. The assertions 220 form a list of functional aspects for each I/O of the top-block ports connected (or not connected in the case of some inputs) to top-block interconnect 216 or I/O 206. A stimulus intended to cause each assertion to be triggered is provided in step 510. A result (e.g., triggered, passed or failed) for each assertion is monitored and recorded or logged in step 512. The result may indicate that the assertions are triggered, the assertions are not triggered, the triggered assertions passed or the triggered assertions failed. Moreover, a triggered assertion passed may indicate a functional mode was properly connected, used, unused, disabled or enabled. Likewise, a triggered assertion failed may indicate a functional mode was improperly connected, used, unused, disabled or enabled. If all assertions were triggered, as determined in decision step 514, and all the assertions passed, as determined in decision step 516, and a next level of design is not to be tested, as determined in decision step 518, the validation is complete in step 520. If, however, all assertions were not triggered, as determined in decision step 514, the stimulus is modified in step 522, the stimulus is reapplied in step 510 and the process continues as previously described. If, however, all the assertions did not pass or were not triggered properly, as determined in decision step 516, the design or top-block, the sub-blocks, the one or more assertions or a combination thereof are modified in step 524 and the process repeats as necessary. The stimulus and assertions may also be monitored and observed in a valid functional mode. Note that the one or more assertions can be checked, monitored or verified using a formal verification tool (e.g., EDA simulation tool). If, however, a next design level is to be tested, as determined in decision step 518, the current design or top-block is inserted as a sub-block in a new design or top-block in step 526 and the process loops back to identify or create one or more assertions for the new design or top-block in step 508. A computer program embodied on a computer readable medium can implement the foregoing steps as one or more code segments.

It will be understood by those of skill in the art that information and signals may be represented using any of a variety of different technologies and techniques (e.g., data, instructions, commands, information, signals, bits, symbols, and chips may be represented by voltages, currents, electromagnetic waves, magnetic fields or particles, optical fields or particles, or any combination thereof). Likewise, the various illustrative logical blocks, modules, circuits, and algorithm steps described herein may be implemented as electronic hardware, computer software, or combinations of both, depending on the application and functionality. Moreover, the various logical blocks, modules, and circuits described herein may be implemented or performed with a general purpose processor (e.g., microprocessor, conventional processor, controller, microcontroller, state machine or combination of computing devices), a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. Similarly, steps of a method or process described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. Although preferred embodiments of the present invention have been described in detail, it will be understood by those skilled in the art that various modifications can be made therein without departing from the spirit and scope of the invention as set forth in the appended claims.

What is claimed is:

1. A method for verifying interconnected blocks in a top-block, the method comprising the steps of:
creating one or more assertions for each input/output of one or more IP blocks to be used within the top-block;
creating one or more assertions for each input/output of the top-block;
providing a stimulus intended to cause each assertion to be triggered; and
verifying that a result for each assertion was correct.

2. The method as recited in claim 1, wherein:
the top-block comprises a circuit system design or a sub-block;
the one or more assertions check that the input/output has changed when in a valid functional mode to drive or receive a changing signal;
the input/output comprises a connection, interconnection, port, pin, data or variable; or
the result comprises the assertions are triggered, the assertions are not triggered, the triggered assertions passed or the triggered assertions failed.

3. The method as recited in claim 2, wherein:
the triggered assertion passed indicates a functional mode was properly connected, used, unused, disabled or enabled; or
the triggered assertion failed indicates a functional mode was improperly connected, used, unused, disabled or enabled.

4. The method as recited in claim 1, wherein the top-block is part of an ASIC, FPGA or other circuit design system having input/outputs.

5. The method as recited in claim 1, further comprising the steps of:
creating the top-block with one or more functional modes; or
defining the one or more IP blocks.

6. The method as recited in claim 1, further comprising the step of recording and monitoring the result for each assertion.

7. The method as recited in claim 1, further comprising the steps of:
monitoring and observing the stimulus and assertions in a valid functional mode;
modifying the stimulus whenever an assertion is not triggered; or
analyzing the assertions whenever the result is incorrect.

8. The method as recited in claim 1, further comprising the step of modifying the top-block, the one or more sub-blocks, the one or more assertions or a combination thereof whenever the result is incorrect or not being triggered properly.

9. The method as recited in claim 1, further comprising the step of checking, monitoring and verifying the one or more interconnect or input/output assertions using an EDA simulation tools that support assertion based verification.

10. The method as recited in claim 1, wherein the assertions form a list of functional aspects for each interconnect or input/output.

11. The method as recited in claim 1, further comprising the steps of:
inserting the top-block into a new top-block;
creating one or more assertions for each input/output of the new top-block;
modifying and/or repeating the stimulus and verification steps.

12. A method for verifying interconnected blocks in a top-block, the method comprising the steps of:
creating the top-block with one or more functional modes;
defining one or more sub-blocks for the top-block;
creating one or more assertions for each input/output of the sub-blocks, wherein the one or more assertions check that the input/output has changed when in a valid functional mode to drive or receive a changing signal;
creating one or more assertions for each input/output of the top-block;
providing a stimulus intended to cause each assertion to be triggered;
monitoring and observing the stimulus and assertions in a valid functional mode;
verifying that a result for each assertion was correct; and
analyzing the assertions whenever the result is incorrect.

13. The method as recited in claim 12, wherein:
the top-block comprises a circuit system design or a sub-block;
the input/output comprises a connection, interconnection, port, pin, data or variable; or
the result comprises the assertions are triggered, the assertions are not triggered, the triggered assertions passed or the triggered assertions failed.

14. The method as recited in claim 13, wherein:
the triggered assertion passed indicates a functional mode was properly connected, used, unused, disabled or enabled; or
the triggered assertion failed indicates a functional mode was improperly connected, used, unused, disabled or enabled.

15. The method as recited in claim 12, wherein the top-block is part of an ASIC, FPGA or other circuit design system having input/outputs.

16. The method as recited in claim 12, further comprising the steps of:
recording and monitoring the result for each assertion;
modifying the stimulus whenever an assertion is not triggered; or
modifying the top-block, the one or more sub-blocks, the one or more assertions or a combination thereof whenever the result is incorrect or not being triggered properly.

17. The method as recited in claim 12, further comprising the step of checking and verifying the one or more interconnect or input/output assertions using an EDA simulation tools that support assertion based verification.

18. The method as recited in claim 12, wherein the assertions form a list of functional aspects for each interconnect or input/output.

19. The method as recited in claim 12, further comprising the steps of:
inserting the top-block into a new top-block;
creating one or more assertions for each input/output of the new top-block;
modifying and/or repeating the stimulus, verification and analysis steps.

20. A computer program embodied on a computer readable medium for verifying interconnected blocks in a top-block, the computer program comprising:
a code segment for creating one or more assertions for each input/output of one or more IP blocks to be used in the top-block;
a code segment for creating one or more assertions for each input/output of the top-block;
a code segment for providing a stimulus intended to cause each assertion to be triggered; and
a code segment for verifying that a result for each assertion was correct.
